(19) United States
(12) Patent Application Publication
(10) Pub. No.: US 2018/0064094 A1
(43) Pub. Date: Mar. 8, 2018

(54) SYSTEMS AND METHODS FOR DEFENDING CROPS FROM CROP-DAMAGING PESTS VIA UNMANNED VEHICLES

(71) Applicant: Wal-Mart Stores, Inc., Bentonville, AR (US)

(72) Inventors: Robert L. Cantrell, Herndon, VA (US); John P. Thompson, Bentonville, AR (US); David C. Winkle, Bella Vista, AR (US); Michael D. Atchley, Springdale, AR (US); Donald R. High, Noel, MO (US); Todd D. Mattingly, Bentonville, AR (US); Brian G. McHale, Greater Manchester (GB); John J. O'Brien, Farmington, AR (US); John F. Simon, Pembroke Pines, FL (US)

(21) Appl. No.: 15/696,586

(22) Filed: Sep. 6, 2017

Related U.S. Application Data
(60) Provisional application No. 62/384,826, filed on Sep. 8, 2016.

(51) Int. Cl. A01M 31/00; G05D 1/00; B64D 1/18; B64C 39/02; B64F 1/36; A01M 29/16; A01M 27/00; A01M 23/00; A01M 13/00; A01M 29/06; A01M 1/10

(52) U.S. Cl. CPC A01M 31/002; B64D 47/08; G05D 1/0094; G05D 1/0038; B64D 1/18; B64C 39/024; B64F 1/362; A01M 29/16; A01M 27/00; A01M 23/00; A01M 13/00; A01M 29/06; A01M 1/10; B64C 2201/12; B64C 2201/146; G05D 1/0022

(57) ABSTRACT

In some embodiments, methods and systems of defending a crop-containing area against crop-damaging pests include an unmanned aerial vehicle including a sensor that detects one or more pests in the crop-containing area and an output device configured to eliminate the pest from the crop-containing area. One or more docking stations configured to accommodate the UAV are provided. A computing device configured to communicate with the UAV and the docking station over a network is provided. The UAV is configured to send pest detection data captured by a sensor of the UAV while patrolling the crop-containing area. In return, the computing device is configured to send a signal to the UAV to indicate instructions to the UAV as to how to move or activate the output device in order to eliminate the detected pest from the crop-containing area.

### CROSS-REFERENCE TO RELATED APPLICATION

This application claims the benefit of U.S. Provisional Application No. 62/384,826, filed Sep. 8, 2016, which is incorporated herein by reference in its entirety.

### TECHNICAL FIELD

This disclosure relates generally to defending a crop-containing area from crop-damaging pests, and in particular, to systems and methods for defending a crop-containing area from crop-damaging pests via unmanned vehicles.

### BACKGROUND

Monitoring crops and defending crops against crop-damaging pests is paramount to farmers. Methods of protecting crops from crop-damaging pests include scarecrows or other devices mounted in the crop-containing areas that are designed to generically scare away all pests. Scarecrow or shiny devices mounted on or near crops may be able to scare away some pests (e.g., birds), but usually do not have any effect on other pests (e.g., insects). Methods of protecting crops from crop-damaging pests also include chemical spraying designed to drive away and/or kill pests that attempt to attack the crops. Usually, chemical sprays target one type of pest while not being a deterrent for other types of pests. In addition, chemical spraying of crops is expensive and may not be looked upon favorably by some consumers.

### BRIEF DESCRIPTION OF THE DRAWINGS

Disclosed herein are embodiments of systems, devices, and methods pertaining to defending a crop-containing area from crop-damaging pests via unmanned vehicles. This description includes drawings, wherein:

FIG. 1 is a diagram of a system for defending a crop-containing area against crop-damaging pests in accordance with some embodiments;

FIG. 2 comprises a block diagram of a UAV as configured in accordance with various embodiments of these teachings;

FIG. 3 is a functional block diagram of a computing device in accordance with some embodiments; and

FIG. 4 is a flow diagram of a method of defending a crop-containing area against crop-damaging pests in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally, the systems, devices, and methods described herein provide for defending a crop-containing area against crop-damaging pests via one or more UAVs configured to detect pests in the crop-containing area and eliminate the pests from the crop-containing area and one or more docking stations configured to accommodate and charge UAVs docked thereto.

In one embodiment, a system for defending a crop-containing area against crop-damaging pests includes: at least one unmanned aerial vehicle including at least one sensor configured to detect at least one pest in the crop-containing area and at least one output device configured to eliminate the at least one detected pest; at least one docking station positioned proximate the crop-containing area and configured to accommodate the at least one unmanned aerial vehicle; and a computing device including a processor-based control circuit and configured to communicate with the at least one unmanned aerial vehicle and the at least one docking station via a wireless network. The at least one unmanned aerial vehicle is configured to send a first signal to the computing device via the wireless network, with the first signal including pest detection data captured by the at least one sensor of the at least one unmanned aerial vehicle upon detection, by the at least one sensor, of the at least one pest in the crop-containing area. In response to receipt of the first signal from the at least one unmanned aerial vehicle, the computing device is configured to send a second signal to the at least one unmanned aerial vehicle via the wireless network, with the second signal indicating instructions to the at least one unmanned aerial vehicle for responding to the at least one detected pest.

In another embodiment, a method of defending a crop-containing area against crop-damaging pests includes: providing at least one unmanned aerial vehicle including at least one sensor configured to detect at least one pest in the crop-containing area and at least one output device configured to eliminate the at least one detected pest; providing at least one docking station positioned proximate the crop-containing area and configured to accommodate the at least one unmanned aerial vehicle; providing a computing device including a processor-based control circuit and configured to communicate with the at least one unmanned aerial vehicle and the at least one docking station via a wireless network; detecting, via the at least one sensor of the at least one unmanned aerial vehicle, the at least one pest in the crop-containing area; sending a first signal, from the at least one unmanned aerial vehicle to the computing device via the wireless network, the first signal including pest detection data captured by the at least one sensor of the at least one unmanned aerial vehicle during the detecting step; and sending, from the computing device to the at least one unmanned aerial vehicle via the wireless network and in response to receipt of the first signal from the at least one unmanned aerial vehicle, a second signal indicating instructions to the at least one unmanned aerial vehicle for responding to the at least one detected pest

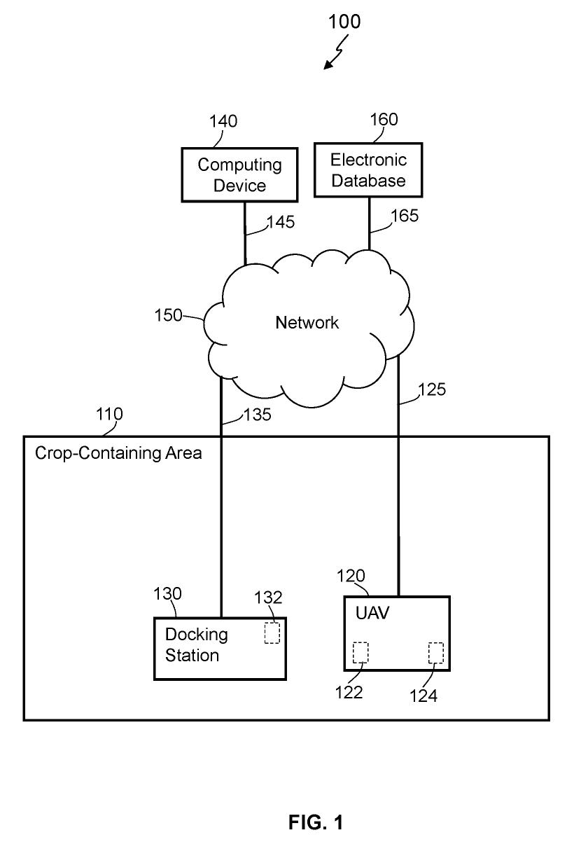

FIG. 1 illustrates an embodiment of a system 100 for defending a crop-containing area 110 against crop-damaging pests. It will be understood that the details of this example are intended to serve in an illustrative capacity and are not necessarily intended to suggest any limitations in regards to the present teachings.

Generally, the exemplary system 100 of FIG. 1 includes a UAV 120 including one or more sensors 122 configured to detect one or more pests in the crop-containing area 110 and one or more output devices 124 configured to eliminate the pest or pests from the crop-containing area 110. It will be appreciated that, in some embodiments, the sensors 122 are configured to detect not only crop-damaging pests, but also animals (e.g., mammals, birds, reptiles, and/or insects) that are not known to cause crop damage. While only one UAV 120 is shown in FIG. 1, it will be appreciated that the system 100 may include two or more UAVs 120 configured to patrol the crop-containing area 110 and to detect and/or eliminate a pest or pests detected in the crop-containing area 110. The system 100 also includes a docking station 130 configured to permit the UAV 120 to land thereon and dock thereto and recharge while patrolling the crop-containing area 110. While only one docking station 130 is shown in FIG. 1, it will be appreciated that the system 100 may include two or more docking stations 130. In addition, while the docking station 130 is shown in FIG. 1 as being located in the crop-containing area 110, it will be appreciated that one or more (or all) docking stations 130 may be positioned outside of the crop-containing area 110. The docking station 130 may be configured as an immobile station or a mobile station. Generally, the UAV 120 is configured to fly above ground through a space overlying the crop-containing area 110, to land onto a docking station 130, and to dock onto the docking station 130 (e.g., for recharging), as described in more detail below.

The exemplary system 100 also includes a processor-based computing device 140 in two-way communication with the UAV 120 (e.g., via communication channels 125 and 145) and/or docking station 130 (e.g., via communication channels 135 and 145) over the network 150, and an electronic database 160 in two-way communication with at least the computing device 140 (e.g., via communication channels 145 and 165) over the network 150. The network 150 may be one or more wireless networks of one or more wireless network types (such as, a wireless local area network (WLAN), a wireless personal area network (PAN), a wireless mesh network, a wireless star network, a wireless wide area network (WAN), a local area network (LAN), a cellular network, and combinations of such networks, and so on), capable of providing wireless coverage of the desired range of the UAV 120 according to any known wireless protocols, including but not limited to a cellular, Wi-Fi or Bluetooth network. In the system 100 of FIG. 1, the computing device 140 is configured to access at least one electronic database 160 via the network 150, but it will be appreciated that the computing device 140 may be configured such that the computing device 140 is directly coupled to the electronic database 160 such that the computing device 140 can access information stored in the electronic database 160 directly and not via the network 150.

It is understood that more or fewer of such components may be included in different embodiments of the system 100. For example, in some embodiments, the docking station 130 is optional to the system 100 and, in such embodiments, the UAV 120 is configured to take off from a deployment station (e.g., stand-alone or vehicle mounted) to initiate patrolling of the crop-containing area 110, and to return to the deployment station without recharging after patrolling the crop-containing area 110. In addition, in some aspects, the computing device 140 and the electronic database 160 may be implemented as separate physical devices as shown in FIG. 1 (which may be at one physical location or two separate physical locations), or may be implemented as a single device. In some embodiments, the electronic database 160 may be stored, for example, on non-volatile storage media (e.g., a hard drive, flash drive, or removable optical disk) internal or external to the computing device 140, or internal or external to computing devices distinct from the computing device 140. In some embodiments, the electronic database 160 is cloud-based.

In some embodiments, the UAV 120 deployed in the exemplary system 100 does not require physical operation by a human operator and wirelessly communicates with, and is wholly or largely controlled by, the computing device 140. In particular, in some embodiments, the computing device 140 is configured to control directional movement and actions (e.g., flying, hovering, landing, taking off, moving while on the ground, generating sounds that scare away or herd pests, etc.) of the UAV 120 based on a variety of inputs. Generally, the UAV 120 of FIG. 1 is configured to move around the crop-containing area, detect one or more crop-damaging pests in the crop-containing area 110, and eliminate such pests from the crop-containing area 110 via deployment the output device 124, or predator-like directional movement. While an unmanned aerial vehicle is generally described herein, in some embodiments, an aerial vehicle remotely controlled by a human may be utilized with the systems and methods described herein without departing from the spirit of the present disclosure. In some embodiments, the UAV 120 may be in the form of a multicopter, for example, a quadcopter, hexacopter, octocopter, or the like. In one aspect, the UAV 120 is an unmanned ground vehicle (UGV) that moves on the ground around the crop-containing area 110 under the guidance of the computing device 140 (or a human operator). In some embodiments, as described in more detail below, the UAV 120 includes a communication device (e.g., transceiver) configured to communicate with the computing device 140 while the UAV 120 is in flight and/or when the UAV 120 is docked at a docking station 130.

The exemplary UAV 120 shown in FIG. 1 includes at least one sensor 122 and at least one output device 124. Generally, the sensor 122 of the UAV 120 is configured to detect an animal (e.g., a crop-damaging pest such as an insect, bird, or mammal and/or an animal that does not damage crops) in the crop-containing area 110 and the output device 124 is configured to eliminate the detected crop-damaging animal from the crop-containing area 110.

In some embodiments, the sensor 122 of the UAV 120 includes a video camera configured to monitor the crop-containing area 110, detect presence of one or more crop-damaging pests in the crop-containing area 110, and capture pest detection data (e.g., a real-time video of the pest, still image of the pest, sounds made by the pest, crop or soil damage caused by the pest, or the like). In one aspect, the sensor 122 is a radar-enabled sensor configured to detect movement of one or more crop-damaging pests outside of the crop-containing area 110, for example, as the crop-damaging pests are approaching the crop-containing area 110, by air, ground, or sea. In one aspect, the sensor 122 is a motion detection-enabled sensor configured to detect movement of one or more crop-damaging pests in the crop-containing area 110. In some embodiments, the video camera of the UAV 120 is configured to be activated in response to the detection of movement, by the motion sensor, of one or more crop-damaging pests in, or adjacent to, the crop-containing area 110. In some embodiments, the video camera is a visible light camera, infrared camera, thermal camera, and/or a night-vision video camera.

In some embodiments, the output device 124 of the UAV 120 is configured to scare away, herd away, or otherwise eliminate one or more pests (e.g., crop-damaging insects, birds, and/or animals) from the crop-containing area 110. In one aspect, the output device 124 includes but is not limited to one or more of: a noise-generating device, a light-generating device, an air-pressure generating device, a chemical substance-spraying device, a projectile-deploying device, a pest herding device, and trap deploying device, or the like.

An exemplary noise-generating device may be configured to emit, for a period of time predetermined by the computing device 140, varying degrees of sounds to act as a deterrent for one or more pests detected by one or more sensors 122 of the UAV 120. For example, after the pest detected by the sensor 122 of the UAV 120 is identified by the computing device 140, as will be described in more detail below, the output device 124 of the UAV may emit a continuous or intermittent sound determined (e.g., by the computing device 140 or a control circuit internal to the UAV 120) to be most optimal to drive the identified pest away from the crop-containing area 110. In one aspect, the output device 124 may, based on an identification of the pest in the crop-containing area 110, use an audio frequency (e.g., ultra sound) predetermined to be most effective to drive away and/or in the future deter the identified pest from the crop-containing area 110.

A light-generating device may, for example, emit one or more lights configured to drive away and/or in the future deter one or more pests from the crop-containing area 110. For example, after the pest detected by the sensor 122 of the UAV 120 is identified by the computing device 140, the output device 124 of the UAV 120 may emit a continuous or intermittent beam of light that was predetermined (e.g., by the computing device 140 or by a control circuit internal to the UAV 120) to be most optimal to drive the detected pest away from the crop-containing area 110. In one aspect, the light-generating device may generate a light that acts as an alert indicative that one or more pests have been detected in the crop-containing area 110 by one or more sensors 122 of the UAV 120. In one aspect, the light-generating device may be configured with a laser-emitting source configured to drive away (i.e., scare) one or more pests from the crop-containing area 110 and/or to eliminate (i.e., kill) one or more pests in the crop-containing area 110.

An air pressure-generating device may, for example, emit one or more jets of gas configured to drive away and in the future deter the pest from the crop-containing area 110. For example, after the pest detected by the sensor 122 of the UAV 120 is identified by the computing device 140, the output device 124 of the UAV 120 may emit a continuous or intermittent jet of gas aimed at the pest. The gas may be air, or a combination of air with an agent that was predetermined (e.g., by the computing device 140 or by a control circuit internal to the UAV 120) to be most optimal to drive the identified pest away from the crop-containing area 110.

A chemical substance-spraying device may, for example, emit one or more chemicals (e.g., via spray, aerosol, mist, or the like) configured to drive away and/or kill and/or in the future deter one or more pests from the crop-containing area 110. For example, after the pest detected by the sensor 122 of the UAV 120 is identified by the computing device 140, the output device 124 of the UAV 120 may emit a continuous or intermittent jet, mist, aerosol, or the like, that includes a chemical aimed at killing the pest and/or driving the pest away from the crop-containing area 110. In some embodiments, the chemical substance-spraying device includes a canister configured to hold a chemical adapted to drive the detected pest away from the crop-containing area 110 upon release of the chemical from the canister and/or put the detected pest to sleep upon release of the chemical from the canister; and/or kill the detected pest upon release of the chemical from the canister. In one aspect, the output device 124 of the UAV 120 includes one or more cartridges or canisters including one or more chemical agent-containing aerosols directed at different pests and the chemical that is sprayed is predetermined (e.g., by the computing device 140 or by a control circuit internal to the UAV 120) to be most optimal to kill the identified pest and/or to drive the identified pest away from the crop-containing area 110. Examples of some suitable insecticide output devices are discussed in co-pending application entitled “SYSTEMS AND METHODS FOR DISPENSING AN INSECTICIDE VIA UNMANNED VEHICLES TO DEFEND A CROP-CONTAINING AREA AGAINST PESTS,” filed Sep. 8, 2016, which is incorporated by reference herein in its entirety.

A projectile-deploying device may, for example, deploy one or more projectiles configured to kill or drive away and in the future deter one or more pests from the crop-containing area 110. For example, after the pest detected by the sensor 122 of the UAV 120 is identified by the computing device 140, the output device 124 of the UAV 120 may deploy a net configured to capture one or more pests (e.g., birds, rabbits, etc.) detected by the UAV 120 in the crop-containing area 110. In one aspect, the output device 124 of the UAV 120 may deploy one or more traps configured to capture one or more pests detected by the UAV 120 in the crop-containing area 110.

In some embodiments, the output device 124 of the UAV 120 includes a trap-deploying device having a trap setting device configured to set a trap designed to capture one or more pests in the crop-containing area 110, and a trap retrieval device configured to retrieve the trap containing the pest after the pest is captured by the trap. In some aspects, the trap-deploying device is configured as a bug zapper, for example, a light- and/or sound-emitting devices configured to attract pests and electrocute the pests while making a “zapping” noise by way of a plurality of electrified elements (e.g., formed as a net, mesh, etc.). In one aspect, the bug zapper may be detachably or non-detachably coupled to the housing 202 and to project outwardly therefrom to attract and electrocute and optionally collect electrocute pests while the UAV 120 is in motion during the patrolling of the crop-containing area 110. In one aspect, the trap includes a transmitter configured to send a signal to the UAV 120 and/or to the computing device 140 to alert the UAV 120 and/or computing device 140 that one or more pests has been captured in the trap. The computing device 140 is configured to then guide the UAV 120 to the location of the pest-containing trap and to deploy the trap retrieval device to retrieve the trap with the captured pest from the crop-containing area 110. In some embodiments, the UAV 120 may be equipped with one or more such traps while docked at a docking station 130, as described in more detail below.

A pest herding device may generate one or more sounds configured to herd one or more pests away from the crop-containing area 110. For example, after the pest detected by the sensor 122 of the UAV 120 is identified by the computing device 140, the pest herding device of the output device 124 of the UAV 120 may emit sounds audible to the pest that were predetermined (e.g., by the computing device 140 or by a control circuit internal to the UAV 120) to be most optimal to herd this pest away from the crop-containing area 110.

In some embodiments, the UAV 120 itself may act as a pest herding device. For example, the UAV 120 may be guided (e.g., by the computing device 140) to move in a way that attracts the attention of one or more pests identified by the sensor 122 of the UAV 120 and that would herd (or otherwise cause movement) of the identified pests away from the crop-containing area 110. In some embodiments, the pest herding device of the UAV 120 may be configured to interact (e.g., by sound) with farmers or herding dogs utilized by farmers to herd undesired pest animals away from the crop-containing area 110. In some embodiments, the pest herding device of the UAV 120 releases one or more chemical agents designed to attract and herd crop-damaging pests away from the crop-containing area 110.

In some embodiments, the UAV 120 is configured in a shape that may scare one or more pests from the crop-containing area 110, and in some aspects, the directional movement of the UAV 120 may be guided by the computing device 140 in a way that the motion of the UAV 120 scares away one or more pests from the crop-containing area 110. For example, for a crop-containing area 110 susceptible to pest birds or small mammals, the UAV 120 according to some embodiments is configured in a shape representing a predatory bird relative to that pest bird or mammal. Then, after the pest bird is detected by the sensor 122 of the UAV 120 and identified by the computing device 140, the motion of the UAV 120 is guided by the computing device 140 or a control circuit internal to the UAV 120 in a way that was predetermined by the computing device 140 or the control circuit internal to the UAV 120 to be most optimal to drive away the pest bird from the crop-containing area 110 without deploying the output device 124 of the UAV 120. It will be appreciated that the mere presence of a UAV 120 shaped like a predatory bird (e.g., eagle, hawk, falcon, etc.) may in itself scare away certain pests (e.g., birds, rabbits, etc.) from the crop-containing area 110 even before such pests are detected by the sensor 122 of the UAV 120.

In some embodiments, the UAV 120 is configured to send a first signal to the computing device 140 (via the wireless network 150) including pest detection data captured by one or more sensors 122 of the UAV 120 upon detection, by the sensor(s) 122, of one or more pests in the crop-containing area 110. In some embodiments, as will be described below, in response to receipt of such a signal from the UAV 120, the computing device 140 is configured to send a second signal to the UAV 120 (via the wireless network 150) indicating instructions to the UAV 120 for responding to the one or more pests detected in the crop-containing area 110.

In some embodiments, one or more sensors 122 of the UAV 120 are configured to detect the presence of at least one type of non-pest crop-damaging factor in the crop-containing area 110 and to capture the characteristics of the presence of such a non-pest crop-damaging factor, which is then analyzed by the computing device 140 to identify the environmental factor responsible for the crop damage, and to determine a set of instructions for the UAV 120 to remedy such a crop-damaging environmental factor. For example, in one aspect, the non-pest damage to one or more crops detectable by the sensor 122 of the UAV 120 in the crop-containing area 110 includes environmental damage including, but not limited to: fungus presence on leaves, fruits, flowers, or stalks of the crops, presence of dark, rotting spots on the fruits growing on the crops (which may be caused by bacteria, mold, mildew, etc.), unbalanced soil content (e.g., indicated by yellowing or dwarfed leaves, etc.), soil damage and/or erosion causes by rain, drought, wind, frostbite, earthquake, over-fertilization, animals (e.g., deer, gophers, moles, grub worms, etc.), and/or other plants or trees (e.g., crop-damaging plants or weeds such as Kudzu, or poisonous plants such as poison ivy). In some embodiments, after receiving data indicating detection of crop damage attributable to one or more such environmental factors from the UAV 120, the computing device 140 instructs the UAV 120 to deploy one or more remedial measures.

For example, in one aspect, if flood damage to crops and/or crop-containing soil is detected by the sensor 122 of the UAV 120 in one corner of the crop-containing area 110, the computing device 140 instructs the UAV 120 to deploy one or more sand bags to the flood-affected area. In another aspect, if soil damage consistent with digging/burrowing pests is detected by the sensor 122 of the UAV 120, the computing device 140 instructs the UAV 120 to deploy one or more predators (e.g., birds such as purple martins, owls, etc., bats, insects such as praying mantis, or certain species of snakes) that would be expected to exterminate and/or scare away the soil damage-causing pests from the affected area. In one aspect, for certain types of detected non-pest crop damage, the computing device 140 instructs the UAV 120 to deploy one or more insects beneficial to crops (e.g., lady bus, bees, etc.) in the affected area in order to improve the health and/or productivity of the crops.

In some embodiments, as described in more detail below, the sensors 122 of the UAV 120 include one or more docking station-associated sensors including but not limited to: an optical sensor, a camera, an RFID scanner, a short range radio frequency transceiver, etc. Generally, the docking station-associated sensors of the UAV 120 are configured to detect and/or identify the docking station 130 based on guidance systems and/or identifiers of the docking station 130. For example, the docking station-associated sensor of the UAV 120 may be configured to capture identifying information of the docking station from one or more of a visual identifier, an optically readable code, a radio frequency identification (RFID) tag, an optical beacon, and a radio frequency beacon.

As discussed above, while only one UAV 120 is shown in FIG. 1 for ease of illustration, it will be appreciated that in some embodiments, the computing device 140 may communicate with and/or provide flight route instructions and/or pest identifying information to two or more UAVs 120 simultaneously to guide the UAVs 120 along their predetermined routes while patrolling the crop-containing area 110 against crop-damaging pests. In some embodiments, the sensors 122 of the UAV 120 may include other flight sensors such as optical sensors and radars for detecting obstacles (e.g., other UAVs 120) to avoid collisions with such obstacles.

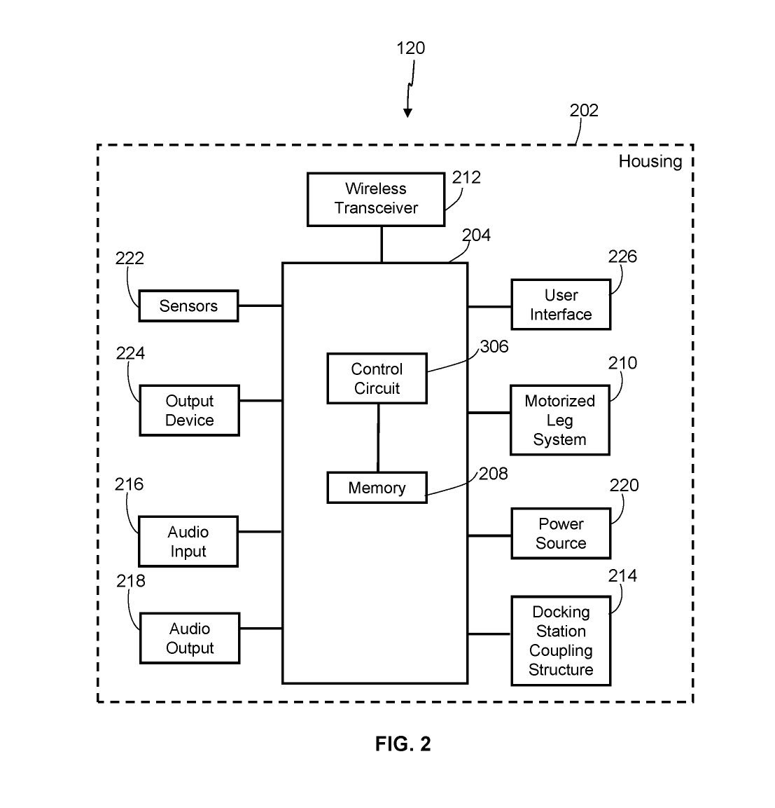

FIG. 2 presents a more detailed example of the structure of the UAV 120 of FIG. 1 according to some embodiments. The exemplary UAV 120 of FIG. 2 has a housing 202 that contains (partially or fully) or at least supports and carries a number of components. These components include a control unit 204 comprising a control circuit 206 that, like the control circuit 310 of the computing device 140, controls the general operations of the UAV 120. The control unit 204 includes a memory 208 coupled to the control circuit 206 for storing data (e.g., pest detection data, instructions sent by the computing device 140, or the like).

In some embodiments, the control circuit 206 of the UAV 120 operably couples to a motorized leg system 210. This motorized leg system 210 functions as a locomotion system to permit the UAV 120 to land onto the docking station 130 and/or move while on the docking station 130. Various examples of motorized leg systems are known in the art. Further elaboration in these regards is not provided here for the sake of brevity save to note that the aforementioned control circuit 206 may be configured to control the various operating states of the motorized leg system 210 to thereby control when and how the motorized leg system 210 operates.

In the exemplary embodiment of FIG. 2, the control circuit 206 operably couples to at least one wireless transceiver 212 that operates according to any known wireless protocol. This wireless transceiver 212 can comprise, for example, a cellular-compatible, Wi-Fi-compatible, and/or Bluetooth-compatible transceiver that can wirelessly communicate with the computing device 140 via the network 150. So configured, the control circuit 206 of the UAV 120 can provide information to the computing device 140 (via the network 150) and can receive information and/or movement and/or pest identification information and/or anti-pest output instructions from the computing device 140.

For example, the wireless transceiver 212 may be caused (e.g., by the control circuit 206) to transmit to the computing device 140, via the network 150, at least one signal indicating pest detection data captured by a pest-detecting sensor 122 of the UAV 120 while patrolling the crop-containing area 110. In some embodiments, the control circuit 206 receives instructions from the computing device 140 via the network 150 to emit a sound via its output device 124 to scare a pest identified by the computing device 140 away from the crop-containing area 110. In one aspect, the wireless transceiver 212 is caused (e.g., by the control circuit 206) to transmit an alert to the computing device 140, or to another computing device (e.g., hand-held device of a worker at the crop-containing area 110) indicating that one or more crop-damaging pests (or animals that do not damage crops) have been detected in the crop-containing area 110. These teachings will accommodate using any of a wide variety of wireless technologies as desired and/or as may be appropriate in a given application setting. These teachings will also accommodate employing two or more different wireless transceivers 212, if desired.

The control circuit 206 also couples to one or more on-board sensors 222 of the UAV 120. These teachings will accommodate a wide variety of sensor technologies and form factors. The on-board sensors 222 can include sensors including but not limited to one or more sensors configured to detect: at least one pest in the crop-containing area 110; the presence and/or location of docking station 130; and the presence and/or location of other UAVs 120. Such sensors 222 can provide information (e.g., pest detection data) that the control circuit 206 and/or the computing device 140 can analyze to identify the pest detected by the sensors 222. For example, the UAV 120 may include an on-board sensor 222 in the form of a video camera and/or a motion sensor configured to detect movement of a pest in the crop-containing area 110 and to capture digital video-based pest detection data that enables visual identification of the pest.

In some embodiments, the sensors 222 of the UAV 120 are configured to detect objects and/or obstacles (e.g., other UAVs 120, docking stations 130, birds, etc.) along the path of travel of the UAV 120. In some embodiments, using on-board sensors 222 (such as distance measurement units, e.g., laser or other optical-based distance measurement sensors), the UAV 120 may attempt to avoid obstacles, and if unable to avoid, the UAV 120 will stop until the obstacle is clear and/or notify the computing device 140 of such a condition.

By one optional approach, an audio input 216 (such as a microphone) and/or an audio output 218 (such as a speaker) can also operably couple to the control circuit 206 of the UAV 120. So configured, the control circuit 206 can provide for a variety of audible sounds to enable the UAV 120 to communicate with the docking station 130 or other UAVs 120. Such sounds can include any of a variety of tones and other non-verbal sounds.

In the embodiment of FIG. 2, the UAV 120 includes a rechargeable power source 220 such as one or more batteries. The power provided by the rechargeable power source 220 can be made available to whichever components of the UAV 120 require electrical energy. By one approach, the UAV 120 includes a plug or other electrically conductive interface that the control circuit 206 can utilize to automatically connect to an external source of electrical energy (e.g., charging dock 132 of the docking station 130) to recharge the rechargeable power source 220. By one approach, the UAV 120 may include one or more solar charging panels to prolong the flight time (or on-the-ground driving time) of the UAV 120.

These teachings will also accommodate optionally selectively and temporarily coupling the UAV 120 to the docking station 130. In such embodiments, the UAV 120 includes a docking station coupling structure 214. In one aspect, a docking station coupling structure 214 operably couples to the control circuit 206 to thereby permit the latter to control movement of the UAV 120 (e.g., via hovering and/or via the motorized leg system 210) towards a particular docking station 130 until the docking station coupling structure 214 can engage the docking station 130 to thereby temporarily physically couple the UAV 120 to the docking station 130. So coupled, the UAV 120 can recharge via a charging dock 132 of the docking station 130.

In some embodiments, the UAV 120 includes an output device 224 that is coupled to the control circuit 206. The output device 224 is configured to eliminate one or more pests detected by the sensors 222 from the crop-containing area 110. As discussed in more detail above, the output device 224 may include but is not limited to a sound-, air-, or light-emitting device (e.g., speaker, nozzle, lamp, etc.) speaker, a pesticide releasing device (e.g., pesticide cartridge and/or spray nozzle, etc.), entrapment device (e.g., net or trap deployment system, etc.), or the like.

In some embodiments, the UAV 120 includes a user interface 226 including for example, user inputs and/or user outputs or displays depending on the intended interaction with a user (e.g., operator of computing device 140) for purposes of, for example, manual control of the UAV 120, or diagnostics, or maintenance of the UAV 120. Some exemplary user inputs include bur are not limited to input devices such as buttons, knobs, switches, touch sensitive surfaces, display screens, and the like. Example user outputs include lights, display screens, and the like. The user interface 226 may work together with or separate from any user interface implemented at an optional user interface unit (e.g., smart phone or tablet) usable by an operator to remotely access the UAV 120. For example, in some embodiments, the UAV 120 may be controlled by a user in direct proximity to the UAV 120 (e.g., a worker at the crop-containing area 110). This is due to the architecture of some embodiments where the computing device 140 outputs the control signals to the UAV 120. These controls signals can originate at any electronic device in communication with the computing device 140. For example, the movement signals sent to the UAV 120 may be movement instructions determined by the computing device 140 and/or initially transmitted by a device of a user to the computing device 140 and in turn transmitted from the computing device 140 to the UAV 120.

The control unit 204 of the UAV 120 includes a memory 208 coupled to a control circuit 206 and storing data such as operating instructions and/or other data. The control circuit 206 can comprise a fixed-purpose hard-wired platform or can comprise a partially or wholly programmable platform. These architectural options are well known and understood in the art and require no further description. This control circuit 206 is configured (e.g., by using corresponding programming stored in the memory 208 as will be well understood by those skilled in the art) to carry out one or more of the steps, actions, and/or functions described herein. The memory 208 may be integral to the control circuit 206 or can be physically discrete (in whole or in part) from the control circuit 206 as desired. This memory 208 can also be local with respect to the control circuit 206 (where, for example, both share a common circuit board, chassis, power supply, and/or housing) or can be partially or wholly remote with respect to the control circuit 206. This memory 208 can serve, for example, to non-transitorily store the computer instructions that, when executed by the control circuit 206, cause the control circuit 206 to behave as described herein. It is noted that not all components illustrated in FIG. 2 are included in all embodiments of the UAV 120. That is, some components may be optional depending on the implementation.

A docking station 130 of FIG. 1 is generally a device configured to permit at least one or more UAVs 120 to dock thereto. The docking station 130 may be configured as an immobile station (i.e., not intended to be movable) or as a mobile station (intended to be movable on its own, e.g., via guidance from the computing device 140, or movable by way of being mounted on or coupled to a moving vehicle), and may be located in the crop-containing area 110, or outside of the crop-containing area 110. For example, in some aspects, the docking station 130 may receive instructions from the computing device 140 over the network 150 to move into a position on a predetermined route of a UAV 120 over the crop-containing area 110.

In one aspect, the docking station 130 includes at least one charging dock 132 that enables at least one UAV 120 to connect thereto and charge. In some embodiments, a UAV 120 may couple to a charging dock 132 of a docking station 130 while being supported by at least one support surface of the docking station 130. In one aspect, a support surface of the docking station 130 may include one or more of a padded layer and a foam layer configured to reduce the force of impact associated with the landing of a UAV 120 onto the support surface of the docking station 130. In some embodiments, a docking station 130 may include lights and/or guidance inputs recognizable by the sensors of the UAV 120 when located in the vicinity of the docking station 130. In some embodiments, the docking station 130 may also include one or more coupling structures configured to permit the UAV 120 to detachably couple to the docking station 130 while being coupled to a charging dock 132 of the docking station 130.

In some embodiments, the docking station 130 is configured (e.g., by including a wireless transceiver) to send a signal over the network 150 to the computing device 140 to, for example, indicate if one or more charging docks 132 of the docking station 130 are available to accommodate one or more UAVs 120. In one aspect, the docking station 130 is configured to send a signal over the network 150 to the computing device 140 to indicate a number of charging docks 132 on the docking station 130 available for UAVs 120. The control circuit 310 of the computing device 140 is programmed to guide the UAV 120 to a docking station 130 moved into position along the predetermined route of the UAV 120 and having an available charging dock 132.

In some embodiments, a docking station 130 may include lights and/or guidance inputs recognizable by the sensors of the UAV 120 when located in the vicinity of the docking station 130. In some aspects, the docking station 130 and the UAV 120 are configured to communicate with one another via the network 150 (e.g., via their respective wireless transceivers) to facilitate the landing of the UAV 120 onto the docking station 130. In other aspects, the transceiver of the docking station 130 enables the docking station 130 to communicate, via the network 150, with other docking stations 130 positioned at the crop-containing area 110.

In some embodiments, the docking station 130 may also include one or more coupling structures configured to permit the UAV 120 to detachably couple to the docking station 130 while being coupled to a charging dock 132 of the docking station 130. In one aspect, the UAV 120 is configured to transmit signals to and receive signals from the computing device 140 over the network 150 only when docked at the docking station 130. For example, in some embodiments, after the pest detected by the UAV 120 in the crop-containing area 110 is identified by the computing device 140, the UAV 120 is configured to receive a signal from the computing device 140 containing an identification of this pest and/or instructions as to how the UAV 120 is respond to the pest only when the UAV 120 is docked at the docking station 130. In other embodiments, the UAV 120 is configured to communicate with the computing device 140 and receive pest identification data and/or pest response instructions from the computing device 140 over the network 150 while the UAV 120 is not docked at the docking station 130.

In some embodiments, the docking station 130 may be configured to not only recharge the UAV 120, but also to re-equip the output device 124 of the UAV 120, and/or to add modular external components to the UAV 120. For example, in some embodiments, the docking station 130 is configured to refill, replace, and/or add one or more cartridges of the output device 124 of the UAV 120 with pest-deterring chemical spray, or to redeploy a net or a compressed air cartridge that was deployed by the output device 124 of the UAV 120 to trap and/or scare away one or more pests from the crop-containing area 110. In some embodiments, the docking station 130 is configured to provide for addition of new modular components to the output device 124 of the UAV 120 to enable the output device 124 to kill or drive away a pest which the output device 124 of the UAV 120 was not previously equipped to kill or drive away.

In some embodiments, the docking station 130 may itself be equipped with an anti-pest output device akin to the output device 124 of the UAV 120 to enable the docking station 130 to generate one or more outputs configured to eliminate (e.g., kill, put to sleep, or repel) one or more crop-damaging pests from the crop-containing area 110. As such, in some aspects of the system 100, anti-pest outputs can be dispensed not only by the UAV 120, but also by the docking station 130, thereby advantageously increasing the anti-pest capabilities of the system 100.

In some embodiments, the docking station 130 is configured to provide for the addition of new modular components to the UAV 120 to enable the UAV 120 to better interact with the operating environment where the crop-containing area 110 is located. For example, in some aspects, the docking station 130 is configured to enable the coupling of various types of landing gear to the UAV 120 to optimize the ground interaction of the UAV 120 with the docking station 130 and/or to optimize the ability of the UAV 120 to land on the ground in the crop-containing area 110. In some embodiments, the docking station 130 is configured to enable the coupling of new modular components (e.g., rafts, pontoons, sails, or the like) to the UAV 120 to enable the UAV 120 to land on and/or move on wet surfaces and/or water. In some embodiments, the docking station 130 may be configured to enable modifications of the visual appearance of the UAV 120, for example, via coupling, to the exterior body of the UAV 120, one or more modular components (e.g., wings) designed to, for example, prolong the flight time of the UAV 120. It will be appreciated that the relative sizes and proportions of the docking station 130 and UAV 120 are not drawn to scale.

The computing device 140 of the exemplary system 100 of FIG. 1 may be a stationary or portable electronic device, for example, a desktop computer, a laptop computer, a tablet, a mobile phone, or any other electronic device. In some embodiments, the computing device 140 may comprise a control circuit, a central processing unit, a processor, a microprocessor, and the like, and may be one or more of a server, a computing system including more than one computing device, a retail computer system, a cloud-based computer system, and the like. Generally, the computing device 140 may be any processor-based device configured to communicate with the UAV 120, docking station 130, and electronic database 160 in order to guide the UAV 120 as it patrols the crop-containing area 110 and/or docks to a docking station 130 (e.g., to recharge) and/or deploys from the docking station 130 and/or generates an output designed to eliminate a pest from the crop-containing area 110.

The computing device 140 may include a processor configured to execute computer readable instructions stored on a computer readable storage memory. The computing device 140 may generally be configured to cause the UAVs 120 to: travel (e.g., fly, hover, or drive), along a route determined by a control circuit of the computing device 140, around the crop-containing area 110; detect the docking station 130 positioned along the route predetermined by the computing device 140; land on and/or dock to the docking station 130; undock from and/or lift off the docking station 130; detect one or more pests in the crop-containing area 110; and/or generate an output (e.g., via the output device 124) configured to eliminate one or more pests from the crop-containing area 110. In some embodiments, the electronic database 160 includes pest identity data associated with crop-damaging pests to facilitate identification of the crop-damaging pests by the computing device 140, and the computing device 140 is configured to determine the identity of the pest based on the pest identity data retrieved from the electronic database 160 and pest detection data captured by the UAV 120, and to instruct the UAV 120 to generate an output against a detected pest based on the identification of that pest by the computing device 140. As such, the pest identity data is stored remotely to the UAV 120 and the determination of the identity of the pest based on the pest detection data is made remotely (at computing device 140) to the UAV 120, thereby advantageously reducing the data storage and processing power requirements of the UAV 120.

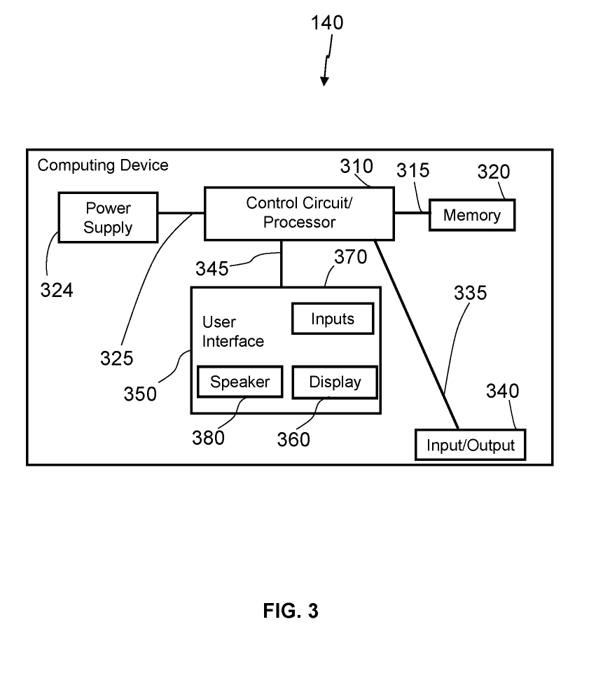

With reference to FIG. 3, a computing device 140 according to some embodiments configured for use with exemplary systems and methods described herein may include a control circuit 310 including a processor (e.g., a microprocessor or a microcontroller) electrically coupled via a connection 315 to a memory 320 and via a connection 325 to a power supply 330. The control circuit 310 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

The control circuit 310 can be configured (for example, by using corresponding programming stored in the memory 320 as will be well understood by those skilled in the art) to carry out one or more of the steps, actions, and/or functions described herein. In some embodiments, the memory 320 may be integral to the processor-based control circuit 310 or can be physically discrete (in whole or in part) from the control circuit 310 and is configured non-transitorily store the computer instructions that, when executed by the control circuit 310, cause the control circuit 310 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control circuit may be referred to as a non-transitory medium or non-transitory computer readable medium.

The control circuit 310 of the computing device 140 is also electrically coupled via a connection 335 to an input/output 340 (e.g., wireless interface) that can receive wired or wireless signals from one or more UAVs 120. Also, the input/output 340 of the computing device 140 can send signals to the UAV 120, such as signals including instructions indicating an identity of a crop-damaging pest detected by the UAV 120 and/or how the insecticide output device 124 of the UAV 120 is to respond to a specific identified pest, or which docking station 130 the UAV 120 is to land on for recharging while patrolling the crop-containing area 110 along a route predetermined by the computing device 140.

In the embodiment shown in FIG. 3, the processor-based control circuit 310 of the computing device 140 is electrically coupled via a connection 345 to a user interface 350, which may include a visual display or display screen 360 (e.g., LED screen) and/or button input 370 that provide the user interface 350 with the ability to permit an operator of the computing device 140, to manually control the computing device 140 by inputting commands via touch-screen and/or button operation and/or voice commands to, for example, to send a signal to the UAV 120 in order to, for example: control directional movement of the UAV 120 while the UAV 120 is moving along a (flight or ground) route (over or on the crop-containing area 110) predetermined by the computing device 140; control movement of the UAV 120 while the UAV 120 is landing onto a docking station 130; control movement of the UAV 120 while the UAV is lifting off a docking station 130; control movement of the UAV 120 while the UAV 120 is in the process of eliminating one or more pests from the crop-containing area 110; and/or control the response of the output device 124 of the UAV 120 to a pest identified in the crop-containing area 110. Notably, the performance of such functions by the processor-based control circuit 310 of the computing device 140 is not dependent on actions of a human operator, and that the control circuit 310 may be programmed to perform such functions without being actively controlled by a human operator.

In some embodiments, the display screen 360 of the computing device 140 is configured to display various graphical interface-based menus, options, and/or alerts that may be transmitted from and/or to the computing device 140 in connection with various aspects of movement of the UAV 120 in the crop-containing area 110 as well as with various aspects of the anti-pest response generated by the output device 124 of the UAV 120 in response to the instructions received from the computing device 140. The inputs 370 of the computing device 140 may be configured to permit a human operator to navigate through the on-screen menus on the computing device 140 and make changes and/or updates to the routes and anti-pest outputs of the UAV 120, as well as to make changes and/or updates to the locations of the docking stations 130. It will be appreciated that the display screen 360 may be configured as both a display screen and an input 370 (e.g., a touch-screen that permits an operator to press on the display screen 360 to enter text and/or execute commands). In some embodiments, the inputs 370 of the user interface 350 of the computing device 140 may permit an operator to, for example, enter an identity of a pest detected in the crop-containing area 110 and to configured instructions to the UAV 120 for responding (e.g., via the output device 124) to the identified pest.

In some embodiments, the computing device 140 automatically generates a travel route for the UAV 120 from its deployment station to the crop-containing area 110, and to or from the docking station 130 while moving over or on the crop-containing area 110. In some embodiments, this route is based on a starting location of a UAV 120 (e.g., location of deployment station) and the intended destination of the UAV 120 (e.g., location of the crop-containing area 110, and/or location of docking stations 130 in or around the crop-containing area 110).

The electronic database 160 of FIG. 1 is configured to store electronic data including, but not limited to: pest detection data captured by the UAV 120 upon detecting one or more pests in the crop-containing area 110; pest identity data associated with the crop-damaging pests to facilitate identification of the crop-damaging pests by the computing device 140 based on the pest detection data; data indicating crop damage patterns attributable to a specified pest or family of pests; data indicating location of the UAV 120 (e.g., GPS coordinates, etc.); data indicating anti-pest output capabilities of the output device 124 of the UAV 120 (e.g., to facilitate addition of new module output components providing further anti-pest capabilities); data indicating anti-pest outputs deployed by the output device 124 of the UAV 120; route of the UAV 120 from a deployment station to the crop-containing area 110; route of the UAV 120 while patrolling the crop-containing area 110; route of the UAV 120 when returning from the crop-containing area 110 to the deployment station; data indicating communication signals and/or messages sent between the computing device 140, UAV 120, electronic database 160, and/or docking station 130; data indicating location (e.g., GPS coordinates, etc.) of the docking station 130; and/or data indicating identity of one or more UAVs 120 docked at each docking station 130.

In some embodiments, location inputs are provided via the network 150 to the computing device 140 to enable the computing device 140 to determine the location of one or more of the UAVs 120 and/or one or more docking stations 130. For example, in some embodiments, the UAV 120 and/or docking station 130 may include a GPS tracking device that permits a GPS-based identification of the location of the UAV 120 and/or docking station 130 by the computing device 140 via the network 150. In one aspect, the computing device 140 is configured to track the location of the UAV 120 and docking station 130, and to determine, via the control circuit 310, an optimal route for the UAV 120 from its deployment station to the crop-containing area 110 and/or an optimal docking station 130 for the UAV 120 to dock to while traveling along its predetermined route. In some embodiments, the control circuit 310 of the computing device 140 is programmed to cause the computing device 140 to communicate such tracking and/or routing data to the electronic database 160 for storage and/or later retrieval.

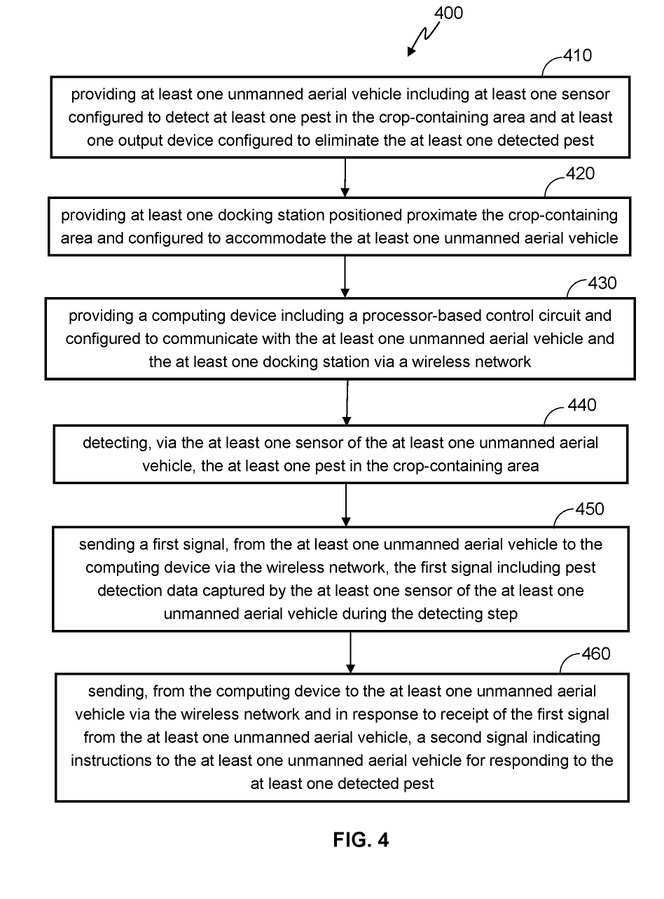

In view of the above description referring to FIGS. 1-3, and with reference to FIG. 4, a method 400 of defending a crop-containing area 110 against crop-damaging pests according to some embodiments will now be described. While the process 400 is discussed as it applies to defending the crop-containing area 110 against crop-damaging pests via one or more UAVs 120 and docking stations 130 as shown in FIG. 1, it will be appreciated that the process 400 may be utilized in connection with any of the embodiments described herein.

The exemplary method 400 depicted in FIG. 4 includes providing one or more UAVs 120 including one or more sensors 122 configured to detect one or more pests in the crop-containing area 110 and one or more output devices 124 configured to eliminate the detected pest or pests from the crop-containing area 110 (step 410). The method 400 also includes providing one or more docking stations 130 positioned proximate (e.g., within, adjacent to, or remote to) the crop-containing area 110 and configured to accommodate one or more UAVs 120 (step 420). As discussed above, in some embodiments, the docking stations 130 are configured to provide for recharging of the UAVs 120, replenishment of various components of the output device 124 of the UAV 120, and/or addition of modular components configured to change the visual appearance of the UAV 120, or to facilitate better interaction of the UAV 120 with its surrounding environment.

The method 400 of FIG. 4 further includes providing a computing device 140 including a processor-based control circuit 310 and configured to communicate with one or more UAVs 120 and one or more docking stations 130 via a wireless network 150 (step 430). The computing device 140 was described in detail above and generally tracks the locations of the UAV 120 and the docking station 130, and controls the movement of the UAV 120 and/or positioning of the docking stations 130 to guide the UAV 120 while it is patrolling the crop-containing area 110 and/or to guide the UAV 120 to the docking station 130 to enable the recharging of the UAV 120 and/or the refilling of existing anti-pest components of the output device 124 of the UAV 120 and/or the coupling of additional modular devices to the UAV 120 as described above.

The method 400 of FIG. 4 further includes detecting, via one or more sensors 122 of the one or more UAVs 120, one or more pests in the crop-containing area 110 (step 440). As discussed above, the pests may be insects, birds, and/or animals capable of damaging the crops in the crop-containing area 110, and the UAV 120 can detect such pests via a sensor 122 configured to capture pest detection data (e.g., a real-time video of the pest, still image of the pest, sounds made by the pest, or the like). The method 400 of FIG. 4 further includes sending a signal from the UAV 120 to the computing device 140 via the wireless network 150, the signal including pest detection data captured by one or more sensors 122 of the UAV 120 during the step of detecting one or more pests in the crop-containing area 110 via the sensors 122 of the UAV 120 (step 450).

In some embodiments, the method 400 further includes sending, in response to the receipt by the computing device 140 of the signal including the pest detection data from the UAV 120, a signal including the pest detection data from the computing device 140 to the electronic database 160. As discussed above, the electronic database 160 is configured for communication with the computing device 140 and includes pest identity data associated with the crop-damaging pests to facilitate identification of the crop-damaging pests by the computing device 140 based on the pest detection data. In one aspect, the electronic database 160 includes a database of video feeds and/or still images of various pests known to damage crops and/or video feeds and/or still images previously transmitted from one or more UAVs 120 to the electronic database 160.

In some embodiments, after the pest detection data captured by the sensor 122 of the UAV 120 and transmitted by the UAV 120 over the network 150 is received by the electronic database 160 (e.g., directly or via the computing device 140), the method 400 includes comparing, at the electronic database 160, the pest detection data received by the electronic database 160 to the pest identity data stored in the electronic database 160 and identifying one or more pests detected by the sensor 122 of the UAV 120. After the pest is identified, the method 400 may further include sending, from the electronic database 160 to the computing device 140, a signal including the comparative data generated at the electronic database 160 and/or data including an identity of the pest detected by the sensor 122 of the UAV 120.

Referring to FIG. 4, the method 400 further includes sending, from the computing device 140 to the UAV 120, via the wireless network 150, and in response to receipt of the signal from the UAV 120 in step 450, a signal indicating instructions to the UAV 120 for responding to the pest detected in the crop-containing area 110 (step 460). In one aspect, the method 400 further includes generating, via the control circuit 310 of the computing device 140, and in response to receipt of the signal including the identity of the pest from the electronic database 160, instructions for the UAV 120 as to how to respond to the identified pest. Such instructions may include, for example, an identification of the component of the output device 124 of the UAV 120 determined by the control circuit 310 of the computing device 140 to be a most optimal response for driving away the identified pest from the crop-containing area 110 or for exterminating the identified pest.

The systems and methods described herein advantageously provide for semi-automated or fully automated monitoring of crop-containing areas via unmanned vehicles to detect one or more crop-damaging pests in the crop-containing areas and to eliminate the pests from the crop-containing areas using the unmanned vehicles while enabling the recharging of such vehicles to advantageously provide for substantially continuous monitoring and protection of crop-containing areas against crop-damaging pests. As such, the present systems and methods significantly reduce the resources needed to protect crop-containing areas from pests, thereby advantageously providing significant cost savings to the keepers of the crop-containing areas.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for defending a crop-containing area against crop-damaging pests, the system comprising:
at least one unmanned aerial vehicle including at least one sensor configured to detect at least one pest in the crop-containing area and at least one output device configured to eliminate the at least one detected pest;
at least one docking station positioned proximate the crop-containing area and configured to accommodate the at least one unmanned aerial vehicle; and
a computing device including a processor-based control circuit and configured to communicate with the at least one unmanned aerial vehicle and the at least one docking station via a wireless network;
wherein the at least one unmanned aerial vehicle is configured to send a first signal to the computing device via the wireless network, the first signal including pest detection data captured by the at least one sensor of the at least one unmanned aerial vehicle upon detection, by the at least one sensor, of the at least one pest in the crop-containing area; and
wherein, in response to receipt of the first signal from the at least one unmanned aerial vehicle, the computing device is configured to send a second signal to the at least one unmanned aerial vehicle via the wireless network, the second signal indicating instructions to the at least one unmanned aerial vehicle for responding to the at least one detected pest.

2. The system of claim 1, further comprising an electronic database in communication with at least one of the computing device and the at least one unmanned aerial vehicle, the electronic database including pest identity data associated with the crop-damaging pests to facilitate identification of the crop-damaging pests based on the pest detection data.

3. The system of claim 2,
wherein the first signal includes pest detection data captured by the at least one sensor of the at least one unmanned aerial vehicle;
wherein in response to the receipt of the first signal including the pest detection data from the at least one unmanned aerial vehicle, the computing device is configured to send a third signal including the pest detection data to the electronic database;
wherein the electronic database is configured to compare the pest detection data in the third signal to the pest identity data in the electronic database to identify the at least one pest detected by the at least sensor of the at least one unmanned aerial vehicle;
wherein the electronic database is configured to send a fourth signal to the computing device, the fourth signal including an identity of the at least one pest detected by the at least one unmanned aerial vehicle; and
wherein, in response to receipt of the fourth signal including the identity of the at least one pest from the electronic database, the control circuit of the computing device is programmed to generate the instructions for the at least one unmanned aerial vehicle for responding to the identified at least one pest.

4. The system of claim 1, wherein the at least one sensor of the at least one unmanned aerial vehicle includes a video camera configured to detect presence of the at least one pest in the crop-containing area and to capture the pest detection data.

5. The system of claim 4,
wherein the at least one sensor is at least one of a radar-enabled sensor configured to detect movement of the at least one pest outside of the crop-containing area, and a motion detection-enabled sensor configured to detect movement of the at least one pest in the crop-containing area; and
wherein the video camera of the at least one unmanned aerial vehicle is configured to be activated in response to detection of movement, by the motion sensor, of the at least one pest in the crop-containing area.

6. The system of claim 1, wherein the at least one unmanned aerial vehicle is configured to send the first signal to the computing device and to receive the second signal from the computing device only when docked at the at least one docking station.

7. The system of claim 1,
wherein the output device includes at least one of a noise-generating device, an air-pressure generating device, a chemical substance-spraying device, a projectile-deploying device, a pest herding device, and trap deploying device; and
wherein the second signal indicating instructions to the at least one unmanned aerial vehicle for responding to the at least one pest includes instructions to cause the at least one unmanned aerial vehicle to eliminate the at least one pest from the crop-containing area via deployment of the at least one of the noise-generating device, air-pressure generating device, chemical substance-spraying device, projectile-deploying device, pest herding device, and trap deploying device.

8. The system of claim 7, wherein the chemical substance-spraying device includes a canister configured to hold a chemical adapted to one of: drive the at least one detected pest away from the crop-containing area upon release of the chemical from the canister, put the at least one detected pest to sleep upon release of the chemical from the canister, and kill the at least one detected pest upon release of the chemical from the canister.

9. The system of claim 7,
wherein the trap deploying device includes a trap setting device is configured to set a trap configured to capture the at least one pest, and a trap retrieval device configured to retrieve the trap containing the at least one pest after the at least one pest is captured by the trap; and
wherein the trap is configured with a transmitter configured to send a fifth signal to at least one of the computing device and the at least one unmanned aerial vehicle to indicate that the at least one pest has been captured in the trap.

10. The system of claim 1,
wherein the at least one pest is a pest bird, and wherein the at least one unmanned aerial vehicle is configured in a shape representing a predatory bird relative to the pest bird; and
wherein the second signal indicating instructions to the at least one unmanned aerial vehicle for responding to the at least one pest includes directional movement instructions to direct movement of the at least one unmanned aerial vehicle toward the pest bird and to eliminate the pest bird from the crop-containing area without deploying the output device.

11. A method of defending a crop-containing area against crop-damaging pests, the method comprising:
providing at least one unmanned aerial vehicle including at least one sensor configured to detect at least one pest in the crop-containing area and at least one output device configured to eliminate the at least one detected pest;
providing at least one docking station positioned proximate the crop-containing area and configured to accommodate the at least one unmanned aerial vehicle;
providing a computing device including a processor-based control circuit and configured to communicate with the at least one unmanned aerial vehicle and the at least one docking station via a wireless network;
detecting, via the at least one sensor of the at least one unmanned aerial vehicle, the at least one pest in the crop-containing area;
sending a first signal, from the at least one unmanned aerial vehicle to the computing device via the wireless network, the first signal including pest detection data captured by the at least one sensor of the at least one unmanned aerial vehicle during the detecting step; and
sending, from the computing device to the at least one unmanned aerial vehicle via the wireless network and in response to receipt of the first signal from the at least one unmanned aerial vehicle, a second signal indicating instructions to the at least one unmanned aerial vehicle for responding to the at least one detected pest.

12. The method of claim 11, further comprising providing an electronic database in communication with at least one of the computing device and the at least one unmanned aerial vehicle, the electronic database including pest identity data associated with the crop-damaging pests to facilitate identification of the crop-damaging pests based on the pest detection data.

13. The method of claim 11,
wherein the first signal includes pest detection data captured by the at least one sensor of the at least one unmanned aerial vehicle and further comprising:
sending, in response to the receipt of the first signal including the pest detection data from the at least one unmanned aerial vehicle, from the computing device to the electronic database, a third signal including the pest detection data;
comparing, at the electronic database, the pest detection data in the third signal to the pest identity data in the electronic database and identifying the at least one pest detected by the at least sensor of the at least one unmanned aerial vehicle;
sending, from the electronic database to the computing device, a fourth signal including an identity of the at least one pest detected by the at least one unmanned aerial vehicle; and
generating, via the control circuit of the computing device, and in response to receipt of the fourth signal including the identity of the at least one pest from the electronic database, the instructions for the at least one unmanned aerial vehicle for responding to the identified at least one pest.

14. The method of claim 11, wherein the providing of the at least one unmanned aerial vehicle including at least one sensor further comprises providing the at least one unmanned aerial vehicle with a video camera configured to detect presence of the at least one pest in the crop-containing area and to capture the pest detection data.

15. The method of claim 14,
wherein the providing of the at least one unmanned aerial vehicle including at least one sensor further comprising providing the at least one unmanned aerial vehicle with at least one of a radar-enabled sensor configured to detect movement of the at least one pest outside of the crop-containing area and a motion detection-enabled sensor configured to detect movement of the at least one pest in the crop-containing area; and
activating the video camera of the at least one unmanned aerial vehicle in response to detection of movement, by the motion sensor, of the at least one pest in the crop-containing area.

16. The method of claim 11, further comprising sending the first signal from the at least one unmanned aerial vehicle to the computing device and receiving the second signal from the computing device at the at least one unmanned aerial vehicle only when the at least one unmanned aerial vehicle is docked at the at least one docking station.

17. The method of claim 11,
wherein the providing of the at least one unmanned aerial vehicle further comprises providing the output device including at least one of a noise-generating device, an air-pressure generating device, a chemical substance-spraying device, a projectile-deploying device, a pest herding device, and trap deploying device; and
wherein the second signal indicating instructions to the at least one unmanned aerial vehicle for responding to the at least one pest includes instructions to cause the at least one unmanned aerial vehicle to eliminate the at least one pest from the crop-containing area via deployment of the at least one of the noise-generating device, air-pressure generating device, chemical substance-spraying device, projectile-deploying device, pest herding device, and trap deploying device.

18. The method of claim 17, wherein the providing of the at least one unmanned aerial vehicle further comprises providing the chemical substance-spraying device including a canister configured to hold a chemical adapted to one of: drive the at least one detected pest away from the crop-containing area upon release of the chemical from the canister, put the at least one detected pest to sleep upon release of the chemical from the canister, and kill the at least one detected pest upon release of the chemical from the canister.

19. The method of claim 17,
wherein the providing of the at least one unmanned aerial vehicle further comprises providing the trap deploying device including a trap setting device configured to set a trap configured to capture the at least one pest and a trap retrieval device configured to retrieve the trap containing the at least one pest after the at least one pest is captured by the trap; and
providing the trap with a transmitter configured to send a fifth signal to at least one of the computing device and the at least one unmanned aerial vehicle to indicate that the at least one pest has been captured in the trap.

20. The method of claim 11,
wherein the at least one pest is a pest bird, and wherein the providing of the at least one unmanned aerial vehicle further comprises configuring the at least one unmanned aerial vehicle in a shape representing a predatory bird relative to the pest bird; and
wherein the second signal indicating instructions to the at least one unmanned aerial vehicle for responding to the at least one pest includes directional movement instructions to direct movement of the at least one unmanned aerial vehicle toward the pest bird and to eliminate the pest bird from the crop-containing area without deploying the output device.
